(19) United States
(12) Patent Application Publication
(10) Pub. No.: US 2005/0113200 A1
(43) Pub. Date: May 26, 2005

(54) Power transmission belt, toothed belt and high duty power transmission V belt

(75) Inventors: Shigeki Okuno, Hyogo (JP); Kimichika Ohno, Hyogo (JP)

Correspondence Address: NIXON PEABODY, LLP, 401 9TH STREET, NW, SUITE 900, WASHINGTON, DC, 20004-2128, US

(73) Assignee: Bando Chemical Industries, Ltd., Kobe-shi (JP)

(21) Appl. No.: 10/980,155

(22) Filed: Nov. 4, 2004

(30) Foreign Application Priority Data
Nov. 20, 2003 (JP) 2003-391271

(51) Int. Cl. F16G 1/28; F16G 5/20; F16G 1/00

(52) U.S. Cl. 474/266; 474/237; 474/250

(57) ABSTRACT

In a power transmission belt having a belt body made of a rubber composition, a belt cloth is provided at a friction force acting part of the belt body. The belt cloth is subjected to dipping treatment in a treatment solution obtained by dissolving into a solution a rubber composition in which uncrosslinked ethylene-α-olefin elastomer is mixed with a metal salt of unsaturated carboxylic acid and an organic peroxide as a crosslinking agent.

### CROSS REFERENCE TO RELATED APPLICATIONS

This Non-provisional application claims priority under 35 U.S.C. §119(a) on Patent Application No. 2003-391271 filed in Japan on Nov. 20, 2003, the entire contents of which are hereby incorporated by reference.

### BACKGROUND OF THE INVENTION

1. Field of the Invention

The present invention relates to power transmission belts, toothed belts and heavy duty power transmission V belts.

2. Description of the Prior Art

The circumstances where toothed belts are used for driving overhead cams, fuel injection pumps, water pumps or the like of engines for automobiles have become more and more severer, for example, output power of engines is increased and atmospheric temperature is increased. In addition to the belts for automobiles, heavy duty transmission power has been demanded in toothed belts used for general industrial applications such as injection molding machines. Searing stress applied to the teeth is increased accompanied by increase in a load to the belts increases, which may invites cracking and separation of tooth rubbers, and thereby shortening the tooth chipping lifetime.

As a countermeasure, it has been known that the rigidity of the teeth may be increased for increasing the durability of the teeth. In order to increase the rigidity of the teeth, the elasticity of the rubber composing the teeth must be increased. Therefore, as a rubber composition for power transmission belts having characteristics such as high elasticity, durability, high strength, abrasion resistance, there is proposed in Japanese Patent Application Laid Open Publication No. 5-156086A a rubber composition in which H-NBR is reinforced with a metal salt of unsaturated carboxylic acid.

It has been confirmed that the tooth chipping lifetime can be elongated by lowering the friction coefficients or increasing the abrasion resistance of tooth fabrics provided on the surface of the teeth, in addition to by increasing the elasticity of the composition of the tooth rubbers. Specifically, Japanese Patent Application Laid Open Publication No. 7-151190A discloses the use of nylon 66 or aramid fiber having a high strength as a material of the tooth fabric and permeation of an antifriction agent such as fluoroplastic powder, graphite, molybdenum disulfide, ceramic powder, glass beads, ultrahigh molecular weight polyethylene, through the tooth fabric.

Addition of such antifriction agents improves the durability to tooth chipping, but the antifriction agents are liable to fall off from the surface of the tooth fabric in belt running because of poor interface adhesiveness between the antifriction agents and an adhesive (isocyanate based, epoxy based, resorcin-formalin-latex based or solvent-paste-rubber based adhesive) which permeates through the tooth fabric together with the antifriction agents. Thus, the effects by the antifriction agents cannot last so longer.

Further, combination of the above antifriction agents with a rubber cement in which the aforementioned H-NBR reinforced with the metal salt of unsaturated carboxylic acid is dissolved in a solvent may invite cracking of the belt cloth at low temperature due to embrittlement of the rubber cement.

For tackling the above problems, Japanese Patent Application Laid Open Publication No. 2003-222195A discloses provision of a resin film of polyethylene or the like having a molecular weight of 100,000 to 3,000,000 on the surface of the belt cloth after dipping in a blended rubber of a nitrile rubber and EPDM (ethylene-propylene-diene terpolymers).

Further, a heavy duty power transmission V belts is known which includes: endless tension bands of which tension band body is made of a rubber composition; and a plurality of blocks arranged in the longitudinal direction of the tension bands at regular intervals and respectively meshing and engaging with the tension bands so that power is transmitted by the friction force of the plural blocks against pulleys. In this heavy duty power transmission V belt, the friction force affects on the upper and lower faces of the tension bands due to to-and-fro swinging of the blocks. Therefore, upper and lower belt cloths are provided on the upper and lower faces of the tension bands, respectively, thereby preventing abrasion of the tension bands and breakage of the blocks caused by wobbling of the blocks due to the abrasion. A rubber treatment solution in which uncrosslinked rubber composition is dissolved in an organic solvent is permeated through the upper and lower belt cloth and is dried before forming the tension bands.

Meanwhile, heavy duty power transmission V belts are used under extremely sever condition such as temperature, and therefore, an organic peroxide crosslinking H-NBR composition with which zinc methacrylate is mixed as a rubber composition forming the tension bands is used. In order to make the rubber composition, which is to be adhered to the upper and lower belt cloths by dipping treatment in the rubber cement, to have excellent heat resistance, in addition to such high performance of the tension band body, it is considered to use a rubber cement in which an organic peroxide crosslinking uncrosslinked H-NBR composition is dissolved in an organic solvent.

Furthermore, Japanese Patent Application Laid Open Publication No. 2003-166597A discloses a rubber treatment solution, in which an organic peroxide crosslinking H-NBR composition with which zinc methacrylate is mixed is dissolved in an organic solvent, is permeated through the belt cloth for improving the abrasion resistance of the belt cloth of a heavy duty power transmission V belt and improving the immobility of the blocks by increase in the elasticity of the belt cloth.

Moreover, in order to improve the abrasion resistance of the belt cloth of a heavy duty power transmission V belt and maintaining the immobility of the blocks by reducing attacking of the belt cloth to the blocks, Japanese Patent Application Laid Open Publication No. 2003-12818A discloses that an organic peroxide crosslinking H-NBR containing polyethylene powder having a molecular weight of 1,000,000 or more and reinforced with a metal salt of unsaturated carboxylic acid such as zinc methacrylate, zinc acrylate is used as the rubber cement and a coating layer is formed on the outermost layer of the belt cloth.

As described above, provision of a resin film on the surface after permeation of the blended rubber of a nitrile rubber and EPDM through the belt cloth improves the static adhesiveness between the resin film and the rubber. However, because the film layer as the outermost layer has a higher elasticity than that of the rubber layer, stress focuses on the interface between the film layer and the rubber layer by belt bending and dynamic stimulation such as searing stress from pulleys, with a result that cracking is liable to be generated. Further, such a generated crack grows along the interface, thereby causing separation between the rubber layer and the film layer. In addition, the use of such a resin film increases the cost of the belt materials.

The aforementioned belt cloth treatment solution in heavy duty power transmission V belts, of which base rubber is H-NBR, is inferior in resistance to cracking at low temperature and causes cracking in the rubber layer permeated through the belt cloth at low temperature, thus inviting breakage of the belt cloth.

### SUMMARY OF THE INVENTION

The present invention has its object of providing a power transmission belt including a belt cloth excellent in heat resistance, cold resistance, abrasion resistance, adhesion and abrasion resistance and silence.

The present invention uses, as a belt cloth provided at a friction force acting portion of a power transmission belt, a belt cloth subjected to an dipping treatment in a treatment solution in which a rubber composition obtained by mixing a metal salt of unsaturated carboxylic acid and an organic peroxide as a crosslinking agent with an uncrosslinked ethylene-α-olefin elastomer is dissolved in a solvent.

With the use of the above treatment solution, the rubber composition to be adhered to the belt cloth of the power transmission belt is made of an organic peroxide crosslinking ethylene-α-olefin elastomer having high heat resistance and high cold resistance, and therefore, the belt cloth itself has high heat resistance and high cold resistance after crosslink of the rubber composition and the strength and the elasticity of the rubber adhered to the belt cloth are increased by the metal salt of unsaturated carboxylic acid, with a result of increase in abrasion resistance of the belt cloth.

As the above ethylene-α-olefin elastomer, ethylenepropylene copolymer (EPM), EPDM or ethyleneoctene copolymer are preferable.

The above metal salt of unsaturated carboxylic acid is a substance in which an unsaturated carboxylic acid having a carboxyl group and a metal are ion-bonded to each other. As the unsaturated carboxylic acid, there are monocarboxylate such as acrylic acid and methacrylic acid, dicarboxylate such as maleic acid, fumaric acid and itaconic acid, and monomethylmaleate and monomethylitaconate. As the metal salt, which is not limited only if it forms an unsaturated carboxylic acid and salt, there may be generally used beryllium, magnesium, calcium, strontium, barium, titanium, chromium, molybdenum, manganese, iron, cobalt, nickel, copper, silver, zinc, cadmium, aluminum, tin, lead, mercury, antimony. Among all, zinc dimethacrylate and zinc diacrylate are suitably used for reinforcing the rubber.

The ethylene-α-olefin elastomer may be directly reinforced with the above metal salt of unsaturated carboxylic acid, but hydrogenated acrylonitrile butadiene rubber in which a metal salt of unsaturated carboxylic acid is finely dispersed may be used for improving dispersion of the metal salt of unsaturated carboxylic acid or increasing the strength and the oil resistance of the belt cloth. Thus, as the treatment solution for the belt cloths of power transmission belts, a substance is preferable in which a rubber composition obtained by mixing hydrogenated acrylonitrile butadiene rubber, in which a metal salt of unsaturated carboxylic acid is dispersed finely, and an organic peroxide as a crosslinking agent with an uncrosslinked ethylene-α-olefin elastomer is dissolved in a solvent.

As commercially available hydrogenated acrylonitrile butadiene rubbers in which a metal salt of unsaturated carboxylic acid is finely disperse, there are Zeoforte ZSC (trade name) produced by ZEON CORPORATION, Therban ART (trade name) produced by Bayer Ltd.

If the polyethylene powder having a molecular weight of 1,000,000 or more is contained in the rubber composition, the lubricity is provided, with a result that the friction coefficient of the belt cloth becomes low. Also, when the ethylene-α-olefin elastomer is crosslinked by the organic peroxide, the polyethylene powder is crosslinked to be chemically integrated with the crosslinked rubber, whereby the polyethylene powder is hard to fall off, the abrasion resistance of the belt cloth is remarkably increased and noise in belt running is reduced. Further, adhesion and abrasion by friction on the surface of the belt cloth is prevented from being caused in the presence of the metal salt of unsaturated carboxylic acid and the polyethylene powder.

It is noted that the polyethylene powder having a molecular weight of 1,000,000 or more is polyethylene of ultrahigh molecular weight, which is excellent in abrasion resistance, lubricity and shock resistance, compared with a polyethylene having a usual high density of 20,000 to 300,000 molecular weight. Further, an antifriction agent such as fluoroplastic powder, graphite, molybdenum disulfide, ceramic powder, glass beads, carbon fiber, organic fiber may be permeated through the belt cloth in combination according to necessity.

The above organic peroxide is not limited specifically but may be, for example, 2,5-dimethyl-2,5-di(t-buthylperoxy)-3-hexyne, 2,5-dimethyl-2,5-di(t-buthylperoxy)hexane, 2,2-bis(t-butylperoxy)-p-diisopropylbenzene, dicumylperoxide, di-t-butylperoxide, t-butylperoxybenzoate, 1,1-bis(t-butylperoxy)-3,3,5-trymethylcyclohexane, 2,4-dichlorobenzoylperoxide, benzoylperoxide, p-chlorobenzoylperoxide, 2,4-dicumylperoxide, dialkylperoxide and ketalperoxide. Further, there may be used according to necessity a general co-crosslinking agent such as sulfur, multifunctional monomer typified by higher esters of methacrylate, 1,2-polybutadiene, triallylisocyanate, and dioxime.

The above solvent is not specifically limited if it can dissolve the rubber composition, and may be toluene, methyl ethyl ketone (hereinafter referred to as “MEK”) and the like.

The above belt cloth is not limited specifically and may be a woven fabric of nylon fiber, aramid fiber or the like, or a textile.

Further, it has ben usual to treat the belt cloth for a power transmission belt with a resin-based adhesive such as an epoxy resin based or isocyanate based resin adhesive or a resin adhesive of a condensate of resorcin and formalin before treatment with a rubber treatment solution as above for ensuring the adhesiveness between the belt body and the belt cloth. However, such resin based adhesives have insufficient flex fatigue resistance, and therefore, stress focuses locally on a crack generated due to insufficient flex fatigue resistance of the resin based adhesive, thereby inviting cutting of the tooth fabric. The inventors of the present invention have found this fact.

In other words, the inventors have found that if the belt cloth is subjected to treatment with the above rubber treatment solution without using the above resin based adhesive so as to adhere the rubber treatment solution to the fiber composing the belt cloth directly, the flex fatigue resistance of the belt cloth is increased and adhesiveness between the belt cloth and the belt body is sufficiently ensured.

The belt cloth treated with the above treatment solution is not limited specifically and may be applied to various kinds of power transmission belts such as a toothed belt having teeth at regular intervals in the longitudinal direction of the belt for transmitting power by engagement with pulleys, a friction power transmission V belt of which section is a trapezoidal and which has a belt cloth at the back face of the belt, a friction power transmission V ribbed belt in which a plurality of ribs each having a V shape in section and each extending in the longitudinal direction of the belt are provided at the inner peripheral face of the belt and a belt cloth is provided at the back face thereof, a friction power transmission raw edge V belt having a belt cloth at the inner peripheral face or the back face of the belt, a friction power transmission flat belt having a belt cloth at the inner peripheral face or the back face of the belt, a heavy duty power transmission V belt in which blocks are assembled to the aforementioned tension bands.

Namely, the above belt cloth can be applied to belt cloths (tooth fabrics) provided on the sides where teeth of the above tooth belts are formed, back face belt cloths provided on the opposite sides (back face sides) of the above toothed belts, back face belt cloths of the V belts or the V ribbed belts, back face belt cloths of the raw edge V belts, belt cloths provided on the inner peripheral sides or the back face sides of the flat belts, and upper or lower belt cloths of the tension bands of the heavy duty power transmission belts.

For example, the toothed belt, which transmits power by meshing the teeth thereof with pulleys, receives high friction force at the tooth fabric thereof, but the employment of the above belt cloth attains remarkable effects of abrasion restraint and noise reduction, with results of excellent tooth chipping resistance and silent belt running.

In the case when the back face of the toothed belt, the V belt, the V ribbed belt or the raw edge V belt is wound to pulleys, employment of the above belt cloth to the back face belt cloth of such a power transmission belt attains remarkable effects of abrasion restraint and noise reduction, with a result of silent belt running.

The aforementioned upper and lower belt cloths of the tension band of the heavy duty power transmission V belt receive friction force caused by to-and-fro swinging of the blocks. However, the employment of the above belt cloth increases the strength and the elasticity by the metal salt of unsaturated carboxylic acid contained in the rubber of the belt cloth, in addition to increase in heat resistance and cold resistance of the belt cloth itself, resulting in increased abrasion resistance.

In addition, the use of the treatment solution for the belt cloths for power transmission belts to which polyethylene powder having a molecular weight of 1,000,000 or more is added provides lubricity to the upper belt cloth and the lower belt cloth, whereby the friction coefficient of the belt cloths is constrained to be low and the polyethylene powder is crosslinked in crosslink of the ethylene-α-olefin elastomer by the organic peroxide so that both substances are chemically integrated with each other. Thus, polyethylene is prevented from falling off, the abrasion resistance of the belt cloth is increased remarkably and breakage of the blocks and noise generation by wobbling of the blocks are prevented.

The rubber composition forming the rubber part in which the belt cloth of the belt body is provided in the aforementioned various power transmission belts is not limited specifically, and may be EPDM compositions, chloroprene rubber (CR) compositions, sulfur-crosslinking H-NBR compositions, organic peroxide crosslinking H-NBR compositions and the like.

### BRIEF DESCRIPTION OF THE DRAWINGS

The other objects, features and benefits of the present invention will be clarified in the following description with reference to accompanying drawings.

FIG. 1 is a perspective view of a toothed belt according to Embodiment 1.

FIG. 2 is a perspective view of a heavy duty power transmission V belt according to Embodiment 2.

FIG. 3 is a sectional view taken along a line II-II in FIG. 2.

FIG. 4 is a side view of a block.

FIG. 5 is a side view of a tension band.

FIG. 6 is a diagram showing a construction of a friction coefficient measuring equipment.

FIG. 7 is a diagram showing a layout of pulleys of a belt running test apparatus for durability test for a toothed belt.

FIG. 8 is a diagram showing a layout of pulleys of a belt running test apparatus for noise test for a toothed belt.

FIG. 9 is a diagram showing a layout of pulleys of a belt running test apparatus for durability test for a heavy duty power transmission V belt.

FIG. 10 is a diagram showing a layout of pulleys of a belt running test apparatus for noise test for a heavy duty power transmission belt.

FIG. 11 is a table indicating constitution of tested belt cloths.

FIG. 12 is a table indicating test results.

### DETAILED DESCRIPTION OF THE PREFERRED EMBODIMENT

The working examples of the present invention will be described below in detail with reference to accompanying drawings.

### Embodiment 1

Toothed Belt Construction

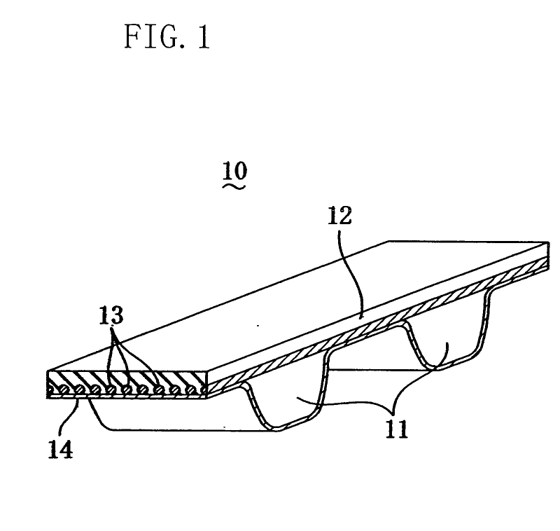

FIG. 1 shows a toothed belt 10 according to Embodiment 1.

In the toothed belt 10, a belt body is composed of teeth 11, 11 . . . provided at given intervals in the longitudinal direction of the belt on the inner peripheral face and a belt back face part 12 on the outer peripheral face. Between the teeth 11 and the back face part 12, a pair of core wires 13, 13 in double spirals as tensile cords are provided integrally with the belt body, extending in the longitudinal direction of the belt and forming a pitch in the width direction of the belt. A belt cloth 14 is attached to the inner peripheral face, which is the teeth 11 side, so as to cover the surface of the teeth 11, 11 . . . The toothed belt 10 transmits power by meshing the teeth 11 with pulleys.

The teeth 11 and the belt back face part 12 are integrally formed of an organic peroxide crosslinked EPDM rubber composition obtained by heat-and-press formation of an uncrosslinked EPDM composition. Wherein, the uncrosslinked EPDM composition is obtained by mixing a filler such an organic peroxide (e.g., dicmyl peroxide) as a crosslinking agent and carbon black as a reinforcer and reinforced by adding a metal salt monomer such as zinc dimethacrylate, zinc diacrylate. This organic peroxide crosslinked EPDM composition is excellent in heat resistance and cold resistance and has high elasticity, which means that the teeth 11, 11 . . . have extremely high elasticity.

Each core wire 13 is formed in a manner that a plurality of strands of first-twisted glass fiber fluxes coated with a resorcin-formalin-latex (hereinafter referred to as “RFL”) film are gathered and are final-twisted, of which direction is reverse to the first twist, to obtain a glass cord and the surface of the thus obtained glass cord is subjected to coating treatment with a rubber cement. Each core wire 13 is integrally adhered to the belt body in a manner that the rubber cement in the surface layer of the core wires 13 adheres to the RFL film coating the glass fiber and is mutually diffused with the rubber composition of the belt body in heat-and-press formation. In one of the pair of core wires 13, 13, the first twist means S twist and the final twist means Z twist. In the other one, the final twist means S twist and the first twist means Z twist.

The belt cloth 14 is formed in a manner that: a rubber treatment solution is prepared by dissolving into an organic solvent such as toluene, an uncrosslinked EPDM composition to which polyethylene powder having a molecular weight of 1,000,000 or more and an organic peroxide such as dicumyl peroxide as a crosslinking agent are mixed and which is reinforced by adding a metal salt monomer such as zinc dimethacrylate, zinc diacrylate: aramid woven fabric processed to have elasticity in the longitudinal direction of a belt is dipped into the thus prepared rubber treatment solution and is dried; and the fabric is subjected to coating with a rubber cement of an organic peroxide crosslinking uncrosslinked EPDM composition for adhesion to the surface of the belt body. The rubber layer thus formed on the surface of the fiber composing the aramid woven fabric by the dipping treatment with the rubber treatment solution and the drying treatment has a thickness of several tens to several hundreds μm. In the belt cloth 14, the rubber component in the rubber treatment solution is crosslinked by the organic peroxide in the heat-and-press formation, and the organic peroxide crosslinked uncrosslinking EPDM rubber component with which the polyethylene powder having a molecular weight of 1,000,000 or more is mixed is adhered to the fabric thoroughly from the surface to the inside thereof. The rubber component adhered by the coating of the rubber cement is crosslinked by the organic peroxide in the heat-and-press formation and is mutually diffused with the rubber composition of the belt body, thereby integrally adhering to the belt body.

Toothed Belt Manufacturing Method

Next, a method for manufacturing the toothed belt 10 will be described.

Sheet-Like Uncrosslinked EPDM Composition Preparing Step

A metal salt monomer such as zinc dimethacrylate, zinc diacrylate or a H-NBR reinforced with a metal salt monomer such as zinc dimethacrylate, zinc diacrylate is added to an uncrosslinked EPDM as a material rubber, and the material rubber to which the metal salt monomer or the reinforced H-NBR is added is masticated in a rubber kneading apparatus such as a Banbury mixer. Next, a filler such as an organic peroxide (e.g., dicumyl peroxide) as a crosslinking agent or carbon black as a reinforcer is injected thereto for kneading. The thus kneaded uncrosslinked EPDM composition is processed to a sheet by calendaring.

Core Wires Preparing Step

Glass fiber fluxes are dipped in an RFL solution and are dried, and then, the grass fiber fluxes are first twisted in a given direction to prepare strands. Wherein, two kinds of strands are prepared, one of which is S twisted as the first twist and the other is Z twisted as the first twist. Next, plural strands are final twisted together in the reverse direction to that of the first twist to prepare glass cords. In detail, strands that is S twisted as the first twit is subjected to the final twist as Z twist and strands that is Z twisted as the first twist is subjected to the final twist as S twist. Then, the thus final twisted glass cords are dipped in a rubber cement and is dried to form a rubber cement layer on the surface thereof, thereby completing the core wire 13.

Preparing Belt Canvas Preparing Step

Similar to the step of preparing a sheet-like uncrosslinked EPDM composition, a metal salt monomer such as zinc dimethacrylate, zinc diacrylate or a H-NBR reinforced with a metal salt monomer such as zinc dimethacrylate, zinc diacrylate is added to an uncrosslinked EPDM as a material rubber, and the material rubber to which the metal salt monomer or the reinforced H-NBR is added is masticated. Thereafter, polyethylene powder having a molecular weight of 1,000,000 or more and an organic peroxide such as dicumyl peroxide as a crosslinking agent are mixed therewith and kneaded, thereby obtaining the uncrosslinked EPDM composition. Also, a rubber cement of an organic peroxide crosslinking uncrosslinked EPDM composition is prepared by kneading and the thus prepared rubber cement is dissolved in an organic solvent such as toluene to obtain a rubber cement.

Next, the thus prepared rubber treatment solution is moved in a treatment bath and an aramid woven fabric having elasticity in one direction, which is to be the belt cloth 14, is dipped therein so that the rubber treatment solution is permeated through the aramid woven fabric. Thereafter, the aramid woven fabric is pull out from the treatment bath for drying. According to necessity, the belt cloth 14 may be dipped in an epoxy resin solution and dried or may be dipped in an RFL solution and dried, beforehand for easy adhesion of the rubber component.

Subsequently, the rubber cement is coated on one surface of the aramid woven fabric by a knife coater or a roll coater and dried to form a layer of the rubber cement. Then, the aramid woven fabric is processed into a cylindrical shape so that the face on which the rubber cement is coated appears outside and the direction that the aramid woven fabric has the elasticity accords with the peripheral direction, to thus complete the belt cloth 14 of the cylindrical shape.

Material Setting Step

A cylindrical mold in which toothed groove extending in the axial direction of the mold is formed in the peripheral direction at regular intervals is covered with the cylindrical belt cloth 14. A pair of the core wire 13 S twisted as the final twist and the core wire 13 Z twisted as the final twist are wound thereover in double spirals at a given pitch. Then, the sheet-shaped uncrosslinked EPDM composition is wound thereover given-number times.

Thus, the belt cloth 14, the core wires 13 and the uncrosslinked EPDM composition are set in layers on the peripheral face of the cylindrical mold in this order from the mold.

Heat-and-Press Formation Step

The cylindrical mold to which the materials are set is put into a heat-and-press apparatus and is maintained for a given period of time while setting the apparatus to given temperature and pressure. In this time, while crosslink of the EPDM composition proceeds, the uncrosslinked EPDM composition flows into the grooves formed in the cylindrical mold so as to push the belt cloth 14, whereby the belt body having the teeth 11 is formed. Mutual diffusion of the rubber cement in the surface portion of the core wires 13 and the belt body allows the core wires 13 to adhere integrally to the belt body. Also, mutual diffusion of the rubber cement coated on the belt cloth 14 of the belt body side and the belt body allows the belt cloth 14 to adhere integrally to the belt body. Thus, a cylindrical slab is formed around the surface of the cylindrical mold.

Cutting Step

The cylindrical slab formed around the peripheral face of the cylindrical mold is detached from the mold after taking the mold out from the heat-and-press apparatus, and then, is cut in round slices to have a given width. Thus, the toothed belt 10 is obtained.

Operation and Effects

In the toothed belt 10 having the aforementioned construction, the rubber component adhered to the belt cloth 14 is made of an organic peroxide crosslinking ethylene-α-olefin elastomer having high heat resistance and high cold resistance. Therefore, the heat resistance and the cold resistance of the belt cloth 14 itself are increased and the strength and the elasticity of the rubber are increased by the metal salt of unsaturated carboxylic acid contained in the rubber component thereof, with a result of increased abrasion resistance of the belt cloth 14.

The hydrogenated acrylonitrile butadiene rubber in which the metal salt of unsaturated carboxylic acid is finely dispersed is mixed with the ethylene-α-olefin elastomer, instead of reinforcement of the ethylene-α-olefin elastomer with the metal salt of unsaturated carboxylic acid, thereby further increasing the strength and increasing oil resistance. Further, when the polyethylene powder having a molecular weight of 1,000,000 or more is contained in the rubber composition, lubricity is provided and the friction coefficient of the belt cltoh is constrained to be low. Further, when the ethylene-α-olefin elastomer is crosslinked by the organic peroxide, the polyethylene powder is co-crosslinked to be chemically integral. Hence, the polyethylene powder is prevented from falling off and the abrasion resistance of the belt cloth 14 is remarkably increased. In addition, noise in running of the toothed belt 10 can be reduced.

Further, with the metal salt of unsaturated carboxylic acid and the polyethylene powder, it is possible to prevent adhesive and abrasion caused on the surface of the belt cloth by friction. The rubber component adhered to the belt body and the belt cloth 14 is made of the organic peroxide crosslinking EPDM composition, whereby the belt is excellent in heat resistance and cold resistance as a whole.

### Embodiment 2

Construction of Heavy Duty Power Transmission V Belt

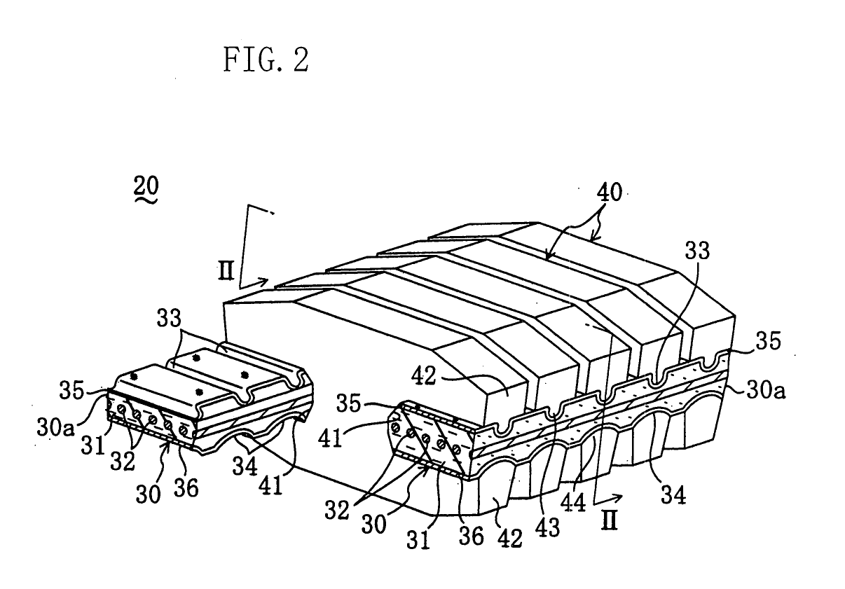

FIG. 2 shows a heavy duty power transmission V belt 20 according to Embodiment 2.

The heavy duty power transmission V belt 20 includes a pair of right and left endless tension bands 30, 30 and a plurality of blocks 40, 40, . . . continually engaged with the tension bands 30, 30 in the longitudinal direction of the belt.

Each tension band 30 is integrally composed of a shape retaining rubber layer 31, spirally provided core wires 32 extending in the shape retaining rubber layer 31 in substantially the longitudinal direction and forming a pitch in the width direction, and upper and lower belt cloths 35, 36 that cover the upper and lower surface thereof, respectively. Groove-shaped upper concave parts 33, 33, . . . extending in the width direction of each tension band 30 are formed at regular intervals in the upper part of each tension band 30 so as to correspond to the blocks 40, respectively, and lower concave parts 34, 34, . . . extending in the width direction of each tension band 30 are formed at regular intervals in the lower part thereof so as to correspond to the upper concave parts 33, 33 . . . , respectively.

The shape retaining rubber layer 31 is made of an EPDM composition obtained in a manner that uncrosslinked EPDM composition, with which an organic peroxide such as dicumyl peroxide as a crosslinking agent and silica or organic short fiber such as aramid fiber, 6,6 nylon fiber as a reinforcer are mixed and which is reinforced by adding a metal salt monomer such as zinc dimethacrylate, zinc diacrylate, is subjected to heat-and-press formation to be crosslinked by the organic peroxide. Thus, the shape retaining rubber layer 31 is excellent in heat resistance and cold resistance and is a hard rubber hard to be permanently deformed. As the hard rubber of the shape retaining rubber layer 31, a rubber is used which has a rubber hardness of 75° or higher when measured by a JIS-C hardness meter.

Each core wire 32 is formed of a twist yarn or a braided cord of aramid fiber having high strength and high elasticity subjected to dipping treatment in a RFL solution and a rubber cement and then is dried. Accordingly, the rubber cement in the surface layer of each core wire 32 is adhered to the RFL and is diffused mutually with the shape retaining rubber layer 31 in forming the tension bands by applying heat and pressure, thereby integrally adhered to the shape retaining rubber layer 31.

The upper and lower belt cloths 35, 36 are formed of the aramid woven fabric processed to have elasticity in the longitudinal direction of the tension bands. This woven fabric is prepared by permeating a rubber treatment solution in which an uncrosslinked EPDM composition is dissolved in an organic solvent such as MEK and dried, wherein the uncrosslinked EPDM composition is obtained by mixing and kneading: an uncrosslinked EPDM; a metal salt monomer such as zinc dimethacrylate, zinc diacrylate or a H-NBR reinforced with a metal salt monomer such as zinc dimethacrylate, zinc diacrylate; polyethylene powder having a molecular weight of 1,000,000 or more; and an organic peroxide such as dicumyl peroxide as a crosslinking agent. The rubber layer formed on the surface of the fiber composing the aramid woven fabric by the dipping in the rubber treatment solution and the drying has a thickness of several tens to several hundreds μm. In the upper and lower belt cloths 35, 36, the rubber component in the rubber treatment solution is crosslinked by the organic peroxide in forming the tension bands by applying heat and pressure, and the EPDM composition with which the polyethylene powder having a molecular weight of 1,000,000 or more is mixed and which is crosslinked by the organic peroxide is adhered to the woven fabric thoroughly from the surface to inside thereof. Also, the EPDM composition is diffused mutually with the shape retaining rubber layer 31, thereby integrally adhering to the shape retaining rubber layer 31.

Each block 40 has cut-in engaging grooves 41, 41 so that the tension bands 31 are detachably fitted sideways from the right or left side in the width direction of the belt, and contact parts 42, 42 respectively at the right and left side faces except the engaging grooves 41 which come in contact with pulley grooves. The tension bands 30, 30 are engaged with the respective engaging grooves 41, 41 of each block 40, whereby the blocks 40 mesh and engage with the tension bands 30, 30 in the longitudinal direction of the belt continually.

A ridge-shaped upper convex part 43 to be meshed with the upper concave part 33 in the upper part of each tension band 30 projects from the upper wall face of each engaging groove 41 of each blocks 40, and a ridge-shaped lower convex part 44 to be meshed with the lower concave part 34 in the lower part of each tension band 30 projects from the lower face thereof. The upper and lower convex parts 43, 44 of each block 40 are arranged in parallel to each other and are meshed with the upper and lower concave parts 33, 34 of each tension band 30, respectively, whereby the blocks 40, 40, . . . are engaged with the tension bands 30, 30 in the longitudinal direction of the belt.

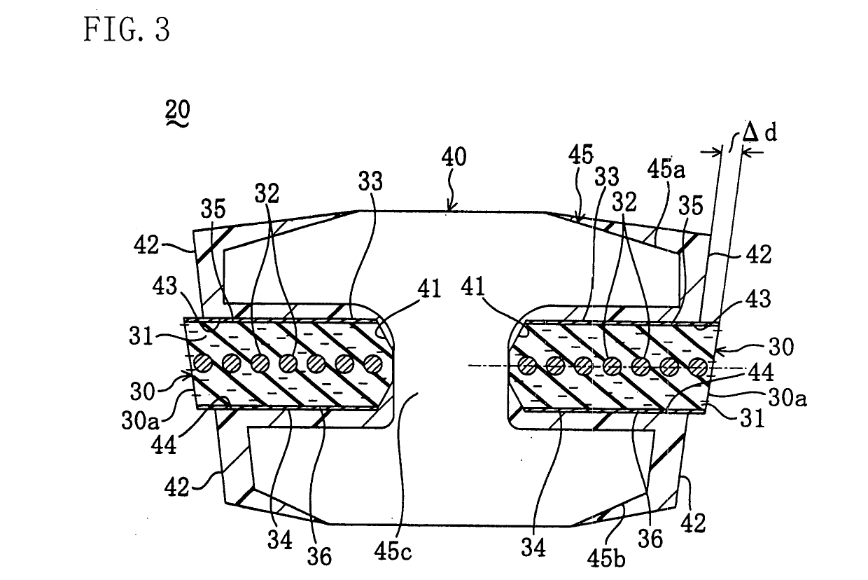

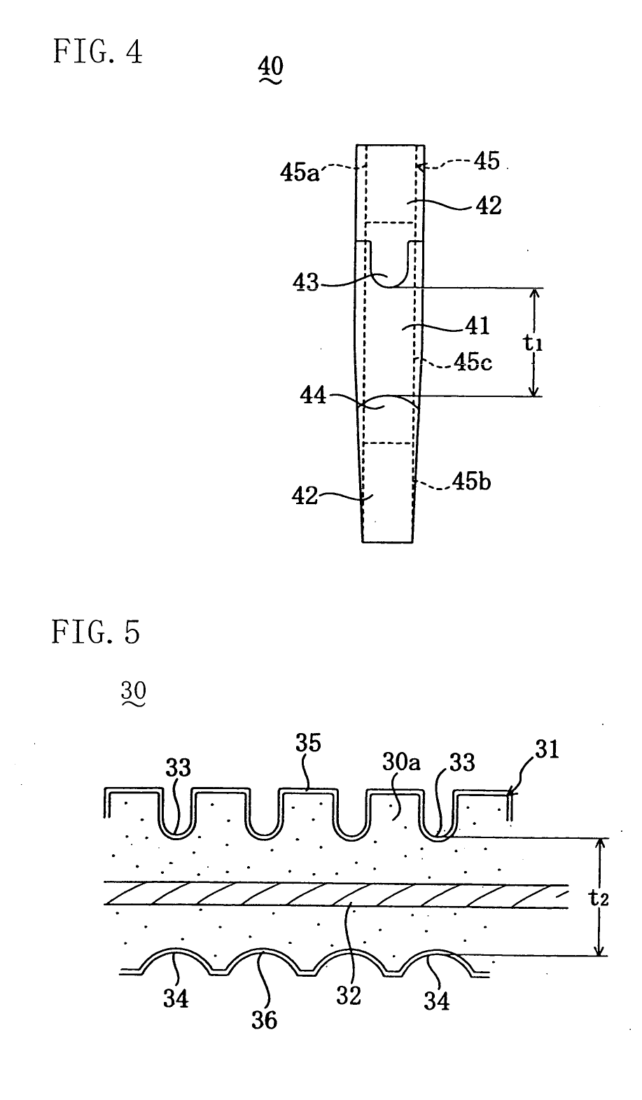

Each block 40 is made of a hard thermosetting phenol resin material with which aramid short fiber, milled carbon fiber or the like is mixed, and a reinforcing member 45 of high strength and high elasticity made of light-weighted aluminum alloy or the like is embedded at the substantial center of each block 40 in the thickness direction of the block 40, as shown in FIG. 3 and FIG. 4. In the reinforcing member 45, the upper and lower convex parts 43, 44 (meshing parts with the tension bands 30) and the contact parts 42, 42 at the right and left side faces (contact parts with pulley grooves) are embedded in the hard resin so as not to be exposed as the surface of the block 40, in other words, these parts are made of the hard resin. However, the other part of the reinforcing member 45 may be exposed as the surface of the block 40.

The reinforcing member 45 is composed of upper and lower beams 45a, 45b extending in the width direction of the belt (sideways) and a center pillar 45c that connects the centers in width direction of both the beams 45a, 45b, to be formed substantially in H-shape.

The thickness t2 (thickness at the meshing part) between the upper and lower concave parts 33, 34 of each tension band 30, that is, the distance between the bottom face of the upper concave part 33 (precisely, the upper surface of the upper belt cloth 35) and the bottom face of the lower concave part 34 corresponding to the upper concave part 33 (precisely, the lower surface of the lower belt cloth 36) shown in FIG. 5 is set beforehand about, for example, 0.03 to 0.15 mm greater than the dimension t1 of the meshing groove of each block 40, that is, the distance between the lower end of the upper convex part 43 and the upper end of the lower convex part 44 of each block 40 shown in FIG. 4 (t2>t1). Accordingly, the tension bands 30 are compressed by the blocks 40 in the thickness direction to be meshed therewith in assembling the blocks 40 to the tension bands 30, with a compression margin (t2-t1: initial compression margin of the tension band 30 against the block 40) provided.

As shown in FIG. 3, tension band side face 30a outside in the width direction of the belt protrude slightly (e.g., 0.03 to 0.15 mm) from the level of the surface of the resin-made contact parts 42, 42 of each block 40 in the pulley contact faces on the right and left sides of the V belt 20. This protrusion serves as a protrusion margin Δd of each tension band 30 so that both tension band side faces 30a and the contact parts 42 at the right and left side faces of each block 40 come in contact with the surface of pulley groove.

The protrusion margin Δd is provided so as to intentionally protrude the tension band side face 30a from the contact part 42 at each side face of each block 40 when the V belt 20 is assembled. The protrusion margin Δd is changeable by adjusting the width of each the tension band 30 (width on a plane passing through the core wires 32) with respect to the depth of each engaging groove 41 serving as the meshing part of each block 40 (groove depth on a plane passing through the core wires 32 of each tension band 30 when fitted to the corresponding engaging groove 41). The tension bands 30 are pushed against and inserted in the engaging grooves 41 of the blocks 40, respectively. In order to complete the pushing and insertion, force greater than the force that the V belt 20 receives from pulleys in actual use is necessary. The protrusion margin Δd can be measured easily by scanning the right and left side faces of the V belt 20 after assembly by a contour tracer (contour measuring tool).

The protrusion margin Δd is provided so that each tension band side face 30a protrudes outward than the contact part 42 on each side of each block 40, so that both the tension band side faces 30a and the contact parts 42 on the sides of each block 40 come in contact with pulley grooves, whereby each block 40 and each tension band 30 share the side pressure from pulleys. Hence, impact at insertion of each block 40 into the pulley groove is dampened by the side faces 30a of the tension bands 30.

High Duty Power Transmission V Belt Manufacturing Method

A method for manufacturing the heavy duty power transmission V belt 20 will be described next.

Sheet-Like Uncrosslinked EPDM Composition Preparing Step

A metal salt monomer such as zinc dimethacrylate, zinc diacrylate or a H-NBR reinforced with a metal salt monomer such as zinc dimethacrylate, zinc diacrylate is added to an uncrosslinked EPDM as a material rubber, and the material rubber to which the metal salt monomer or the reinforced H-NBR is added is masticated in a rubber kneading apparatus such as a Banbury mixer. Next, a filler such as an organic peroxide (e.g., dicumyl peroxide) as a crosslinking agent and silica, organic short fiber or the like as a reinforcer are injected thereto and kneaded. The thus kneaded uncrosslinked EPDM composition is processed into a sheet by calendaring.

Core Wires Preparing Step

Twist yarns or braided cords of aramid fiber are dipped in the RFL solution, and then, are dried. It is possible that the twist yarns or the braided cords are dipped in an epoxy solution or an isocyanate solution and are dried before the adhesion treatment by the RFL solution. Subsequently, the twist yarns or the braded cords to which the RFL is thoroughly adhered are dipped in the rubber cement, and dried. Thus, the core wires 32 are completed.

Upper and Lower Canvases Preparing Step

Similar to the sheet-like uncrosslinked EPDM composition preparing step, a metal salt monomer such as zinc dimethacrylate, zinc diacrylate or a H-NBR reinforced with a metal salt monomer such as zinc dimethacrylate, zinc diacrylate is added to uncrosslinked EPDM as a material rubber, and the material rubber to which the metal salt monomer or the reinforced H-NBR is added is masticated. Thereafter, polyethylene powder having a molecular weight of 1,000,000 or more and an organic peroxide such as dicumyl peroxide as a crosslinking agent are mixed therewith and kneaded, thereby preparing the uncrosslinked EPDM composition. The thus prepared uncrosslinked EPDM composition is dissolved in an organic solution such as toluene to prepare a rubber treatment solution.

Subsequently, the thus prepared rubber treatment solution is moved in a treatment bath, and aramid woven fabrics having elasticity in one direction, which are to be the upper and lower belt cloths 35, 36, respectively, are dipped in the rubber treatment solution so that the rubber treatment solution is permeated through the aramid woven fabrics. Thereafter, the aramid woven fabrics are taken out from the treatment bath for drying. According to necessity, the upper and lower belt cloths 35, 36 may be dipped in an epoxy resin solution and dried or may be dipped in an RFL solution and dried, beforehand for easy adhesion of the rubber component.

Subsequently, the rubber cement is coated on one surface of the aramid woven fabric by a knife coater or a roll coater and dried to form a layer of the rubber cement. Each aramid woven fabrics are processed into cylindrical shapes so that the rubber cement coated side serves as the outer peripheral face and the direction that the fabric can stretch accords with the peripheral direction, thereby obtaining the upper and lower belt cloths 35, 36.

Tension Band Forming Step

A cylindrical mold, in which grooves having a shape corresponding to the lower concave part of each tension band 30 and extending in the axial direction of the mold are formed at regular intervals in the peripheral direction, is covered with the cylindrically formed lower belt cloth 36, and then, the sheet-like uncrosslinked EPDM composition is wound around it to form a given layer.

Subsequently, the cylindrical mold is put into a heat-and-press apparatus and the apparatus is maintained for a given period of time while setting the temperature and the pressure to given values so as to promote halfway crosslinking of the uncrosslinked EPDM composition. In this time, the crosslinking of the uncrosslinked EPDM composition proceeds halfway to form the lower half shape of the shape retaining rubber layer 31 and the EPDM still uncrosslinked flows into the grooves provided in the cylindrical mold so as to push the lower belt cloth 36, whereby the lower concave parts 34, 34 . . . are formed.

Next, the cylindrical mold is taken out from the heat-and-press apparatus, the core wires 32 are wound spirally over the half-crosslinked EPDM composition at a regular pitch, another uncrosslinked EPDM composition processed in the sheet-like shape is wound thereover to form a given layer, and then, the cylindrically formed upper belt cloth 35 is covered thereover.

Next, a sleeve, in which ridges corresponding to the upper concave parts of the tension bands 30 and extending in the axial direction is provided at a regular pitch in the peripheral direction, is covered over the outermost layer.

Subsequently, the cylindrical mold in which the materials are set is put into a heat-and-press apparatus and the apparatus is maintained for a given period of time while setting the temperature and the pressure to given values. In this time, the crosslinking of the half-crosslinked and uncrosslinked EPDM compositions proceeds and the EPDM still uncrosslinked flows into the grooves provided in the sleeve so as to push the upper belt cloth 35, whereby the upper concave parts 33, 33 . . . are formed to compose the shape retaining rubber layer 31. Further, mutual diffusion of the rubber cement in the surface portion of the core wires 32 and the shape retaining rubber layer 31 promotes integral adhesion of the core wires 32 to the shape retaining rubber layer 31. Also, mutual diffusion of the rubber component adhered to the upper and lower belt cloths 35, 36 and the shape retaining rubber layer 31 promotes integral adhesion of the upper and loser belt cloths 35, 36 to the shape retaining rubber layer 31. Thus, a cylindrical slab is formed on the surface of the cylindrical mold.

Finally, the cylindrical mold is taken out from the heat-and-press apparatus. The cylindrical slab formed on the peripheral face thereof is detached and is cut in round slices, and then, the sliced pieces are chamfered, thereby obtaining the tension bands 30.

Block Forming Step

An aluminum reinforcing member 45 is set into a cavity formed in a block forming mold and a thermosetting phenol resin is injected thereto, thereby forming the blocks 40 in which the reinforcing member 45 is inserted in the resin. Then, the thus formed blocks 40 are subjected to various kinds of formation processing to increase their strength according to necessity.

Assembling Step

The upper and lower concave parts 33, 34 located correspondingly to each other in the tension band 30 are set respectively correspondingly to the upper and lower convex parts 43, 44 and the tension band 30 is inserted in one of the engaging grooves 41 of each block 40, so that the upper convex part 43 and the lower convex part 44 are respectively fitted to the upper concave part 33 and the lower concave part 34 and the block 40 is engaged with the tension band 30. This operation is performed for the entire periphery of the tension band 30. Then, another tension band 30 is inserted into the other engaging groove 41 of each block 40, thereby completing the heavy duty power transmission V belt 20.

Operation and Effects

In the above heavy duty power transmission V belt 20, the rubber component adhered to the upper and lower belt cloths 35, 36 is made of an organic peroxide crosslinking ethylene-α-olefin elastomer having high heat resistance and high cold resistance. Therefore, the heat resistance and the cold resistance of the upper and lower belt cloths 35, 36 themselves are increased. Also, the metal salt of unsaturated carboxylic acid contained in the rubber component increases the strength and the elasticity of the composition, with a result of increase in abrasion resistance of the belt cloth. The ethylene-α-olefin elastomer is reinforced with hydrogenated acrylonitrile butadiene rubber in which the metal salt of unsaturated carboxylic acid is finely dispersed, instead of direct reinforcement with the metal salt of unsaturated carboxylic acid, increases the strength and improves the oil resistance.

The polyethylene powder having a molecular weight of 1,000,000 or more provides lubricity to constrain the friction coefficient of the upper and lower belt cloths 35, 36 to be low. The polyethylene powder is crosslinked in crosslinking of the ethylene-α-olefin elastomer by the organic peroxide, so that both are chemically integrated. Hence the polyethylene powder is hard to fall off, the abrasion resistance of the upper and lower belt cloths 35, 36 is remarkably increased, breakage of the blocks 40 caused by wobbling of the blocks 40 and noise are prevented from being caused.

In addition, the shape retaining rubber layer 31 composing the body of each tension band 30 is also made of the organic peroxide crosslinking EPDM composition. Therefore, the rubber component adhered to the shape retaining rubber layer 31 and the upper and lower belt cloths 35, 36 is excellent in heat resistance an cold resistance, with a result that the V belt 20 is excellent in heat resistance and cold resistance as a whole.

### Other Embodiments

In Embodiments 1 and 2, the polyethylene powder is added to the EPDM composition composing the rubber treatment solution. However, the present invention is not limited specifically. The polyethylene powder may not be added, and an antifriction agent may be added according to necessity such as fluoroplastic powder, graphite, molybdenum disulfide, ceramic powder, glass beads, carbon fiber, organic fiber.

The toothed belt is employed in Embodiment 1 but the present invention is not limited to the toothed belt and may be applied to V belts, V ribbed belts or raw edge V belts having belt cloths on the back faces of the belts and capable of driving pulleys at the back faces, toothed belts having belt cloths at both the faces where the teeth are formed and the back faces, and flat belts having belt cloths at one of or both faces of the belts, only when belt cloths are prepared in the same manner as the belt cloth 14 in Embodiment 1.

The core wires 13 are formed of the glass fiber in Embodiment 1, but the present invention is not limited thereto and the core wires 13 may be formed of aramid fiber.

The rubber composition forming the belt body of the toothed belt 10 in Embodiment 1 and the rubber composition forming the shape retaining rubber layer 31 composing the tension bands 30 of the heavy duty power transmission V belt 20 in Embodiment 2 are made of the organic peroxide crosslinking EPDM composition. However, the rubber composition is not limited thereto specifically and may be an organic peroxide crosslinking hydrogenated acrylonitrile butadiene rubber composition, a composition of a chloroprene rubber (CR) or a sulfur crosslinking H-NBR composition. The polyethylene powder is added to the organic peroxide crosslinking EPDM composition in Embodiments 1 and 2. But the present invention is not limited thereto specifically, and the polyethylene powder may not be added. Also, an antifriction agent may be added according to necessity such as fluoroplastic powder, graphite, molybdenum disulfide, ceramic powder, glass beads, carbon fiber, organic fiber.

In addition, the aramid fiber is used for the belt cloth 14 and the upper and lower belt cloths 35, 36 in Embodiment 1 or 2. But the present invention is not limited to the aramid fiber specifically and nylon fiber may be used.

Test evaluations, which were actually performed, will be described next.

(Test Canvas)

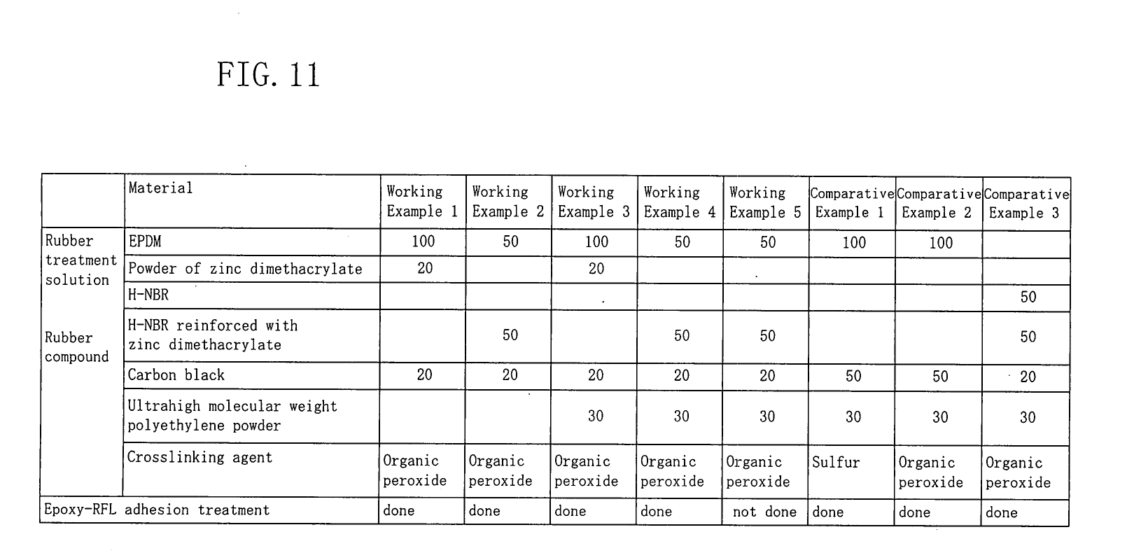

Canvases according to the following examples were prepared. Each constitution thereof is indicated also in FIG. 11.

### WORKING EXAMPLE 1

A woven fabric was prepared in which a covering yarn formed of urethane yarn, to which aramid fiber (TECHNORA (trade name) produced by TEIJIN LIMITED) was wound to provide elasticity, was used as a weft and a nylon twist yarn was used as a warp. The woven fabric was dipped into a solution of an epoxy resin, dried, and was dipped into a RFL solution and dried.

On the other hand, a rubber treatment solution was prepared in which an uncrosslinked EPDM composition, which was obtained by kneading uncrosslinked EPDM (EP24 (trade name) produced by JSR Corporation) of 100 weight part, carbon black of 20 weight part, powder of zinc dimethacrylate (ACTOR ZMA (trade name) produced by Kawaguchi Chemical Industry Co., Ltd.) of 20 weight part and an organic peroxide as a crosslinking agent, was dissolved in toluene. Wherein, the mass ratio of the uncrosslinked EPDM composition to the toluene (uncrosslinked EPDM composition: toluene) was set to be 1:5.

The above woven fabric was subjected twice to dipping in the thus prepared rubber treatment solution and drying, whereby obtaining a belt cloth of Working Example 1.

### WORKING EXAMPLE 2

A belt cloth of Working Example 2 having the same structure as in the belt cloth of Working Example 1 was prepared, except that another rubber treatment solution was used in which an uncrosslinked EPDM composition, which was obtained by kneading an uncrosslinked EPDM (EP24 (trade name) produced by JSR Corporation) of 50 weight part, carbon black of 20 weight part, hydrogenated NBR reinforced with zinc dimethacrylate (Zeoforte ZSC2195CX (trade name) produced by ZEON CORPORATION) of 50 weight part and an organic peroxide as a crosslinking agent, was dissolved in toluene.

### WORKING EXAMPLE 3

A belt cloth of Working Example 3 having the same structure as in the belt cloth of Working Example 1 was prepared, except that another rubber treatment solution was used in which an uncrosslinked EPDM composition, which was obtained by kneading an uncrosslinked EPDM (EP24 (trade name) produced by JSR Corporation) of 100 weight part, carbon black of 20 weight part, powder of zinc dimethacrylate (ACTOR ZMA (trade name) produced by Kawaguchi Chemical Industry Co., Ltd.) of 20 weight part, ultrahigh molecular weight polyethylene powder (MIPELON XM-220 (trade name) produced by Mitsui Chemicals Inc.) of 30 weight part and an organic peroxide as a crosslinking agent, was dissolved in toluene.

### WORKING EXAMPLE 4

A belt cloth of Working Example 4 having the same structure as in the belt cloth of Working Example 1 was prepared, except that another rubber treatment solution was used in which an uncrosslinked EPDM composition, which was obtained by kneading an uncrosslinked EPDM (EP24 (trade name) produced by JSR Corporation) of 50 weight part, carbon black of 20 weight part, hydrogenated NBR reinforced with zinc dimethacrylate (Zeoforte ZSC2195CX (trade name) produced by ZEON CORPORATION) of 50 weight part, ultrahigh molecular weight polyethylene powder (MIPELON XM-220 (trade name) produced by Mitsui Chemicals Inc.) of 30 weight part and an organic peroxide as a crosslinking agent, was dissolved in toluene.

### WORKING EXAMPLE 5

A belt cloth of Working Example 5 having the same structure as in the belt cloth of Working Example 4 was prepared, except that no adhesive treatment (treatment of dipping in the epoxy resin solution of and drying and treatment of dipping in the RFL solution and drying) was performed prior to dipping of the rubber treatment solution.

### COMPARATIVE EXAMPLE 1

A belt cloth of Comparative Example 1 having the same structure as in the belt cloth of Working Example 1 was prepared, except that another rubber treatment solution was used in which an uncrosslinked EPDM composition, which was obtained by kneading an uncrosslinked EPDM (EP24 (trade name) produced by JSR Corporation) of 100 weight part, carbon black of 50 weight part, ultrahigh molecular weight polyethylene powder (MIPELON XM-220 (trade name) produced by Mitsui Chemicals Inc.) of 30 weight part and sulfur as a crosslinking agent, was dissolved in toluene.

### COMPARATIVE EXAMPLE 2

A belt cloth of Comparative Example 2 having the same structure as in the belt cloth of Comparative Example 1 was prepared, except that an organic peroxide was used as the crosslinking agent of the uncrosslinked EPDM composition in the rubber treatment solution.

### COMPARATIVE EXAMPLE 3

A belt cloth of Comparative Example 3 having the same structure as in the belt cloth of Working Example 1 was prepared, except that another rubber treatment solution was used in which an uncrosslinke H-NBR composition, which was obtained by kneading an uncrosslinked H-NBR (Zetpol 2010 (trade name) produced by ZEON CORPORATIN) of 50 weight part, carbon black of 20 weight part, hydrogenated NBR reinforced with zinc dimethacrylate (Zeoforte ZSC2195CX (trade name) produced by ZEON CORPORATION) of 50 weight part, ultrahigh molecular weight polyethylene powder (MIPELON XM-220 (trade name) produced by Mitsui Chemicals Inc.) of 30 weight part and an organic peroxide as a crosslinking agent, was dissolved in toluene

(Test Method)

Preparation of Toothed Belt

Eight kinds of toothed belts respectively using the belt cloths of Working Examples 1-5 and Comparative Examples 1-3 as the belt cloths for covering the teeth of the belts were prepared by following the method described in Embodiment 1. As the rubber composition for forming each belt body composed of the teeth and the belt back face, an organic peroxide crosslinking EPDM composition was used. A glass cord subjected to adhesion treatment with a RFL solution was used as the core wires. The pitch of the teeth was set 8 mm and the belt width is set 10 mm.

Preparation of Heavy Duty Power Transmission V Belt

Eight heavy duty power transmission V belts respectively using the belt cloths of Working Examples 1-5 and Comparative Examples 1-3 as the upper and lower belt cloths for respectively covering the upper and lower faces of the tension bands were prepared by following the method described in Embodiment 2. As the shape retaining rubber layer of the tension band, an organic peroxide crosslinking EPDM composition was used with which aramid short fiber (TECHNORA (trade name) produced by TEIJIN LIMITED) and nylon short fiber were mixed and to which zinc dimethacrylate was added for reinforcement. Braided cords of aramid fiber (TECHNORA (trade name) produced by TEIJIN LIMITED) subjected to adhesion treatment was used as the core wires. The blocks were formed by compositing a reinforcing member made of an aluminum alloy and a phenol resin with which carbon fiber and aramid short fiber (TECHNOLRA (trade name) produced by TEIJIN LIMITED) were mixed. The belt angle was set 26 degrees, the belt pitch was set 25 mm, the block pitch (in longitudinal direction of the belt) was set 3 mm, the thickness of each block was set 2.95 mm and the length of the belt was set to 612 mm.

Test for Friction Coefficient

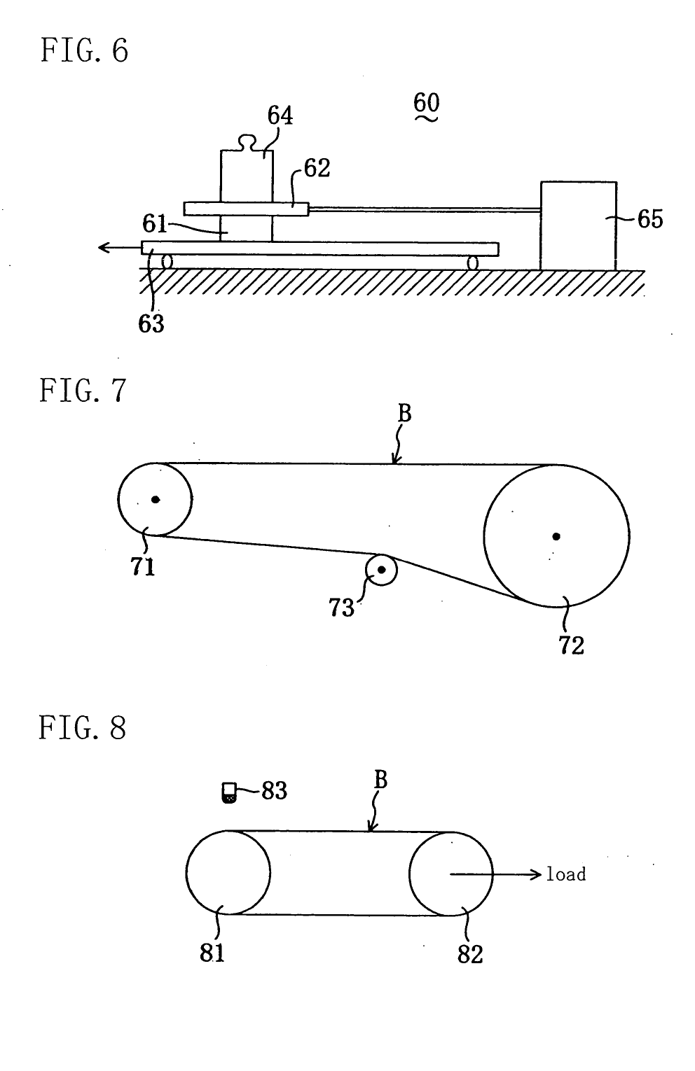

A test was carried out using a friction coefficient measuring apparatus 60 shown in FIG. 6 for obtaining respective friction coefficients between the tooth tips of the toothed belts respectively using the belt cloths of Working Examples 1-5 and Comparative Examples 1-3 and a carbon steel (S45C) used as a material of general pulleys and between the tension bands of the heavy duty power transmission V belts respectively using the belt cloths of Working Examples 1-5 and Comparative Examples 1-3 and a resin forming the blocks.

First, each test piece 61 obtained by cutting a part of the toothed belts was adhered and fixed to a test piece mounting tool 62 so as that the teeth thereof face downward. Then, the tooth tip of each test piece 61 was made in contact with a sliding plate 63 made of the carbon steel (S45C) and a weight 64 was put on the test piece mounting tool 62 so that the sliding plate 63 pressed the tooth tip. The sliding plate 63 was moved in the direction of an arrow to slide the tooth tip on the surface of the sliding plate 63 and the resistance load was detected by a load cell 65 connected to the test piece mounting tool 62. Then, the mass of the weight 64 was subtracted from the thus detected resistance load to calculate the respective friction coefficients.

Also, friction coefficients against the blocks were calculated in the same manner as above, using the test pieces 61 respectively obtained by cutting the tension bands of the heavy duty power transmission V belts and sliding plate 63 made of a phenol resin with which carbon fiber and aramid fiber were mixed as in the blocks.

Running Test of Toothed Belt

Test for Abrasion Resistance of Canvas

Test was carried out using a belt running test apparatus 70 having a layout shown in FIG. 7 for evaluating abrasion resistance of the belt cloths of the toothed belts B using the respective belt cloths of Working Examples 1-5 and Comparative Examples 1-3 against a pulley made of a carbon steel (S45C).

First, each mass of the toothed belts B was measured.

Next, each toothed belt B was wound to the belt running test apparatus 70 composed of a drive pulley 71 having 21 pulley grooves in the pulley periphery, a driven pulley 72 having 42 pulley grooves in the pulley periphery and an idler pulley 73 of which pulley periphery for pushing the back face of the belt was flat. Then, a load was applied backward to the driven pulley 72 to apply a tension of 216 N to the belts.

Each belt was run for 300 hours while applying a load so that the belt B received a tension of 550 N. Thereafter, each mass of the toothed belts after the run was measured. Each mass difference of the toothed belt B between before and after the run was calculated as an abrasion amount.

Further, a function as to whether the surface of the teeth of each toothed belt after the run exhibited adhesiveness was evaluated. Three levels were set in the evaluation: namely, the adhesiveness after the run is 1) reduced; 2) increased; and 3) not changed.

Test for Evaluating Resistance to Tooth Chipping

Under the same condition as in the test for evaluating the abrasion resistance, a test was carried out in a manner that the toothed belts respectively using the belt cloths of Working Examples 1-5 and Comparative Examples 1-3 were run until tooth chipping occurred for evaluating running periods as lifetimes in resistance to tooth chipping.

Evaluation for Canvas Cracking at Low Temperature

In an atmosphere at a temperature of −35° C., each belt was run in the same layout as in the evaluation for abrasion resistance for one minute, and then, was cooled. This course of performance was set as one cycle. After 500 cycles, the surface of each belt cloth was observed as to whether a clack was generated.

Noise Test in Belt Running

Test was carried out using a belt running test apparatus 60 having an layout shown in FIG. 8 for evaluating noise in running of the toothed belts B respectively using the belt cloths of Working Examples 1-5 and Comparative Examples 1-3.

First, each toothed belt B was wound to the belt running test apparatus 80 composed of a drive pulley 81 having 24 pulley grooves in the pulley periphery and a driven pulley 81 having 24 pulley grooves in the pulley periphery, and a load was applied backward to the driven pulley 82 so as to apply a constant tension to each toothed belt B.

Then, each toothed belt B was run while changing the number of revolutions in the range between 300 and 5000 rpm, and a maximum noise value was measured by a sound collecting microphone 83 disposed 300 mm above the drive pulley 81.

Running Test of Heavy Duty Power Transmission V Belt

Test for Durability

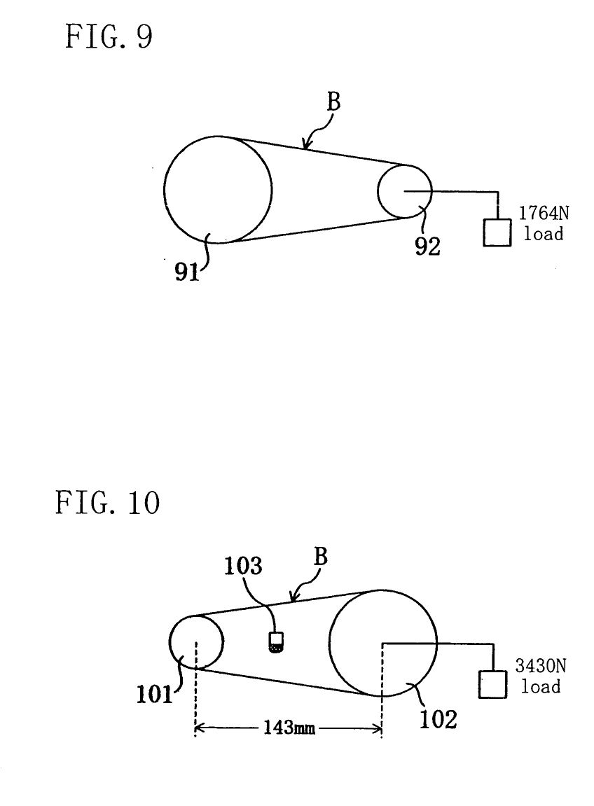

Test was carried out using a belt running test apparatus 90 having an layout shown in FIG. 9 for evaluating, as durable lifetime of the blocks, respective running periods until a breakage was generated in the blocks of the heavy duty power transmission V belts respectively using the belt cloths of Working Examples 1-5 and Comparative Examples 1-3 as the upper and lower belt cloths.

First, each V belt B was wound between a drive pulley 91 having a diameter of 154 mm and provided to a drive shaft and a driven pulley 92 having a diameter of 65 mm and provided to a driven shaft, and a load of 1764 N was applied backward to the driven pulley 92. Then, the drive pulley 91 was rotated at 5000 rpm to run each V belt B (belt speed was 40.3 m/second) and each running period until a breakage of the block was generated is measured.

Tests for Change in Compression Margin Between Before and After Belt Running and for Noise in Belt Running

Test was carried out using a belt running test apparatus 100 having a layout shown in FIG. 10 for evaluating change in compression margin between before and after belt running and for noise in the belt running of the heavy duty power transmission V belts respectively using the belt cloths of Working Examples 1-5 and Comparative Examples 1-3 as the upper and lower belt cloths.

First, the clearance of each engaging groove of each block and the thickness between the upper concave part and the lower concave part of each tension band were measured and the difference therebetween was calculated as an initial compression margin. Then, each V belt B was wound between a drive pulley 101 having a diameter of 65 mm and provided to a drive shaft and a driven pulley 102 having a diameter of 130 mm and provided to a driven shaft, and a load of 3430 N was applied backward to the driven pulley 102. The distance of between the shafts of the drive pulley 101 and the driven pulley 102 was set 143 mm.

The drive pulley 101 was rotated at 2600 rpm to run each V belt B for 200 hours, and a maximum noise value was measured by a sound collecting microphone 103 disposed between the drive pulley 101 and the driven pulley 102. Thereafter, the compression margin after the running was calculated and the number of cracks generated in the tension bands was counted.

Evaluation for Canvas Cracking at Low Temperature

In an atmosphere at a temperature of −35° C., each belt was run in a layout equivalent to that in the evaluation for belt durability for one minute, and then, was cooled. This course of performance was set as one cycle. After 500 cycles, the surface of each belt cloth was observed as to whether crack is generated.

### Experiment Results

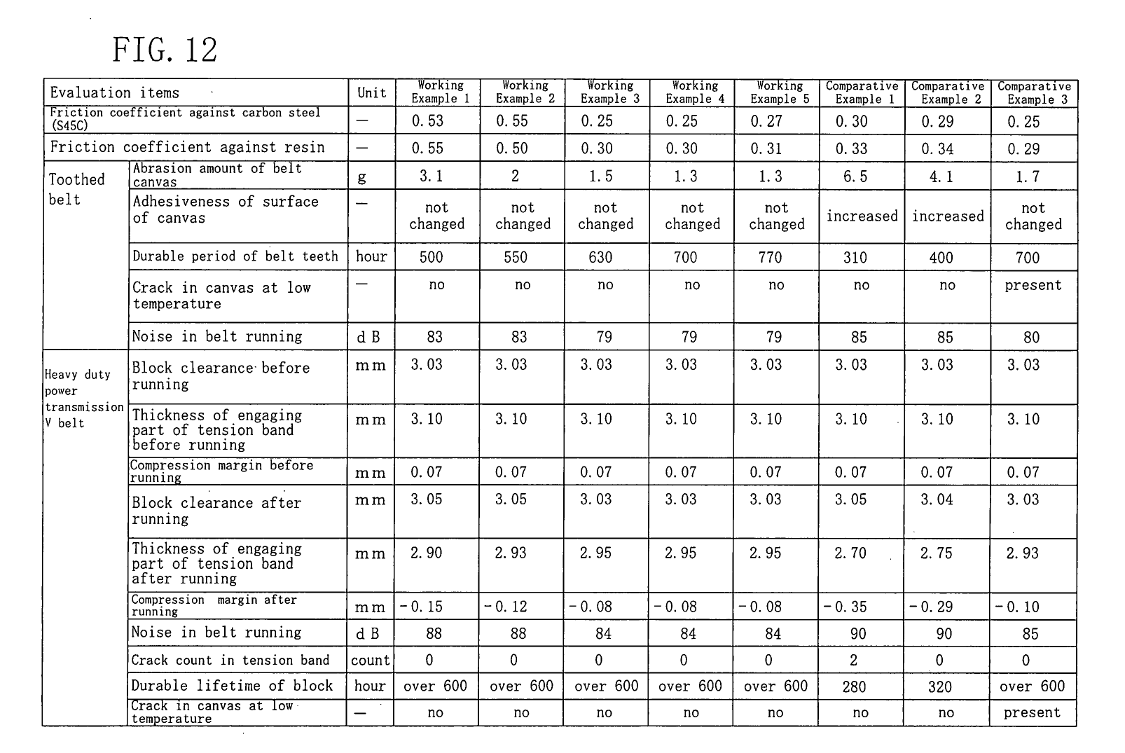

Experiment results are indicated in FIG. 12.

Comparative Example 1 used the rubber treatment solution of the EPDM composition with which ultrahigh molecular weight polyethylene was mixed for attaining abrasion resistance and a low friction coefficient, as indicated in FIG. 11. However, the EPDM, in which the sulfur was used for crosslinking, had insufficient heat resistance, and abrasion of the belt cloth was severe in the toothed belt. This was because sulfur curing worsened adhesiveness between the ultrahigh molecular weight polyethylene and the EPDM serving as a base rubber and led to falling off of the ultrahigh molecular weight polyethylene powder from the belt cloth in belt running. As a result, the durable lifetime of the teeth of the toothed belt was shortened.

Similarly, it is considered that severe reduction of thickness of the engaging part of the tension bands after the running of the heavy duty power transmission V belt is due to severe abrasion of the surface of the belt cloth. Accordingly, the compression margin after the running was extremely reduced and the immobility of the blocks was lowered, resulting in large stress applied to the tension bands, invitation of cracks in the tension bands, severe noise of the belt and shortening of the durable lifetime of the blocks.

In Comparative Example 2, the EPDM composition, which was crosslinked by the organic peroxide, had excellent heat resistance. The interface between the ultrahigh molecular weight polyethylene and the EPDM was crosslinked and adhered securely by the operation of the organic peroxide, and therefore, the ultrahigh molecular polyethylene powder did not fall off. However, with no reinforcement with zinc dimethacrylate, insufficient abrasion resistance was obtained.

In Comparative Examples 1 and 2 with no reinforcement with zinc dimethacrylate, adhesiveness at the surface was increased after abrasion of the belt cloth of each toothed belt, with a result of increase in noise.

In Comparative Example 3, the hydrogenated acrylonitrile butadiene rubber was reinforced with the composition crosslinked by the organic peroxide and zinc dimethacrylate, and the abrasion resistance was increased and the friction coefficient was lowered by the ultrahigh molecular weight polyethylene. Accordingly, excellent effects were obtained, namely, excellent abrasion resistance of the belt cloth, excellent durability of the teeth of the toothed belt, low noise in running, invariance of the compression margin of the heavy duty power transmission V belt, invariance of the immobility of the blocks, noise reduction, excellent resistance to cracking of the tension bands and longer durable lifetime of the blocks. However, with the used of the H-NBR as the base rubber, the resistance to cracking of the belt cloth at low temperature was poor.

In contrast, Working Example 1 used the EPDM reinforced with zinc dimethacrylate and crosslinked by the organic peroxide, and therefore, the EPDM composition composing the treatment solution for the belt cloth was improved in heat resistance, cold resistance and abrasion resistance. As a result, the belt cloth of the toothed belt was improved in abrasion resistance, adhesion resistance and durability of the teeth. With the improvement in heat resistance and abrasion resistance of the belt cloth, the heavy duty power transmission V belt exhibited the same effects as above in invariance of the compression margin, invariance of the immobility of the blocks, noise reduction, improvements in resistance to cracking and in durability of the blocks.

The EPDM composition, in which the EPDM was mixed with the H-NBR reinforced with zinc dimethacrylate and was crosslinked by the organic peroxide as in Working Example 2, instead of direct reinforcement of the EPDM with zinc dimethacrylate, was improved in abrasion resistance, which led to more excellent effects than those obtained in Invention Working Example 1.

Addition of the ultrahigh molecular weight polyethylene and crosslink by the organic peroxide as in Working Examples 3 and 4 lowered extremely the friction coefficient against the carbon steel and the resin of the belt cloth. Further, the interface between the ultrahigh molecular weight polyethylene and the EPDM was firmly crosslinked and adhered by the organic peroxide, thereby preventing the ultrahigh molecular weight polyethylene powder from falling off. As a result, the abrasion resistance of the belt cloth was improved further than that in Working Example 2 and excellent effects were obtained in all of the items.

Furthermore, in the case where the belt cloth was subjected to no pretreatment with the epoxy resin and RFL as in Working Example 5, the flex fatigue resistance of the belt cloth was improved compared with that in Working Example 4, thereby elongating the durable lifetime of the teeth of the toothed belt. Though no explicit effect was observed in the heavy duty power transmission V belt, it is clear that the improvement in flex fatigue resistance of the belt cloth would enhance the resistance to cracking of the tension bands in technical point of view, and thus, it is considered that the effects would be exhibited in the heavy duty power transmission V belt after running for a long period of time.

As described above, the use of the EPDM as the base rubber of a rubber composition used in the rubber treatment solution for belt cloths enhances the resistance to cracking of the belt cloths at low temperature. The use of the rubber composition with which zinc dimethacrylate or the H-NBR reinforced with zinc dimethacrylate is mixed and which is crosslinked by the organic peroxide enhances the heat resistance, the abrasion resistance and the adhesion and abrasion resistance of the belt cloth. Further, addition of the ultrahigh molecular weight polyethylene powder leads to enhancement of the abrasion resistance and lowering of the friction coefficient, with a result of remarkable improvement in durability and silence of the power transmission belt.

In addition, it is found that the flex fatigue resistance of the belt cloth is improved if the belt cloth is subjected to no pretreatment with a resin based adhesive.

The same effects can be obtained when zinc diacrylate or a H-NBR reinforced with zinc diacrylate is used instead of zinc dimethacrylate.

It is clear that the effects obtained in the present invention are obtainable in any power transmission belts in which belt cloths forms the friction faces. Accordingly, the present invention is applicable to V belts, V ribbed belts and raw edge V belts having belt cloths at the back faces of the belts for driving pulleys, toothed belts in which belt cloths are provided on the tooth side faces or both the tooth side faces and the back faces, flat belts in which belt cloths are provided on both faces or one face of the belts, and the like.

It is understood by those skilled in the art that the foregoing description is each preferred embodiment of the disclosed belts and that various changes and modifications may be made in the invention without departing from the spirit and scope thereof.

1. A power transmission belt, comprising:
a belt body formed of a rubber composition; and
a belt cloth provide at a part of said belt body where friction force acts,
wherein said belt cloth is subjected to dipping treatment in a treatment solution in which a rubber composition obtained by mixing a metal salt of unsaturated carboxylic acid and an organic peroxide as a crosslinking agent with uncrosslinked ethylene-α-olefin elastomer is dissolved into a solvent.

2. The power transmission belt of claim 1, wherein
said belt cloth is subjected to dipping treatment in said treatment solution in which said rubber composition obtained by mixing uncrosslinked ethylene-α-olefin elastomer with a hydrogenated acrylonitrile butadiene rubber, in which a metal salt of unsaturated carboxylic acid is disperse, and an organic peroxide as a crosslinking agent is dissolved into a solvent.

3. The power transmission belt of claim 1, wherein
said metal salt of unsaturated carboxylic acid contains at least one of zinc dimethacrylate and zinc diacrylate.

4. The power transmission belt of claim 1, wherein
said treatment solution contains polyethylene powder having a molecular weigh of 1,000,000t or more.

5. The power transmission belt of claim 1, wherein
in said belt cloth, said treatment solution adheres directly to fiber composing said belt cloth.

6. A toothed belt for transmitting power by engaging with a pulley, comprising:
teeth provided at given intervals in a longitudinal direction of said belt
a belt body including a surface portion on which said teeth are formed and another surface portion on an opposite side thereto, one of said surface portions being composed of a rubber composition; and
a belt cloth provided on said surface portion on which said teeth are formed or said surface portion on the opposite side thereto,
wherein said belt cloth is subjected to dipping treatment in a treatment solution in which a rubber composition obtained by mixing a metal salt of unsaturated carboxylic acid and an organic peroxide as a crosslinking agent with uncrosslinked ethylene-α-olefin elastomer is dissolved into a solvent.

7. The toothed belt of claim 6, wherein
said belt cloth is subjected to dipping treatment in said treatment solution in which said rubber composition obtained by mixing uncrosslinked ethylene-α-olefin elastomer with a hydrogenated acrylonitrile butadiene rubber, in which a metal salt of unsaturated carboxylic acid is disperse, and an organic peroxide as a crosslinking agent is dissolved into a solvent.

8. The toothed belt of claim 6, wherein
said metal salt of unsaturated carboxylic acid contains at least one of zinc dimethacrylate and zinc diacrylate.

9. The toothed belt of claim 6, wherein
said treatment solution contains polyethylene powder having a molecular weight of 1,000,000 or more.

10. The toothed belt of claim 6, wherein
in said belt cloth, said treatment solution adheres directly to fiber composing said belt cloth.

11. A heavy duty power transmission V belt comprising:
an endless tension band having a tension band body made of a rubber composition and an upper belt cloth and a lower belt cloth respectively at upper and lower faces thereof; and
a plurality of blocks each meshing and engaging with said tension band and arranged at regular intervals in a longitudinal direction of said tension band so that power is transmitted by friction force of said plural blocks against a pulley,
wherein at least one of said upper belt cloth and said lower belt cloth is subjected to dipping treatment in a treatment solution in which a rubber composition obtained by mixing a metal salt of unsaturated carboxylic acid and an organic peroxide as a crosslinking agent with uncrosslinked ethylene-α-olefin elastomer is dissolved into a solvent.

12. The heavy duty power transmission V belt of claim 11, wherein
said upper belt cloth and/or said lower belt cloth subjected to said dipping treatment in said treatment solution is subjected to dipping treatment in a treatment solution in which said rubber composition obtained by mixing uncrosslinked ethylene-α-olefin elastomer with a hydrogenated acrylonitrile butadiene rubber, in which a metal salt of unsaturated carboxylic acid is disperse, and an organic peroxide as a crosslinking agent is dissolved into a solvent.

13. The heavy duty power transmission V belt of claim 11, wherein
said metal salt of unsaturated carboxylic acid contains at least one of zinc dimethacrylate and zinc diacrylate.

14. The heavy duty power transmission V belt of claim 11, wherein
said treatment solution contains polyethylene powder having a molecular weight of 1,000,000 or more.

15. The heavy duty power transmission V belt of claim 11, wherein
in said upper belt cloth and/or said lower belt cloth subjected to said dipping treatment in said treatment solution, said treatment solution adheres directly to fiber composing said belt cloth.
